(19) United States
(12) Patent Application Publication
(10) Pub. No.: US 2010/0073815 A1
(43) Pub. Date: Mar. 25, 2010

(54) MAGNETIC HEAD AND MAGNETIC DISK DEVICE

(75) Inventors: Kenichiro Aoki, Kawasaki (JP); Toshiyuki Nakada, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/509,879

(22) Filed: Jul. 27, 2009

(30) Foreign Application Priority Data
Sep. 19, 2008 (JP) 2008-241440

(51) Int. Cl. G11B 5/127; G11B 5/33

(52) U.S. Cl. 360/110; 428/810; G9B/5.04

(57) ABSTRACT

A magnetic head provided on a drain end side of a head substrate constituting a head slider includes a heater, a write coil, a shield, an insulation layer between the heater and the head substrate, a thermal insulation layer whose thermal conductivity is lower than the insulation layer and a thermal radiation layer whose thermal conductivity is higher than the shield, wherein the thermal insulation layer is disposed between the heater and the head substrate and the thermal radiation layer is disposed between the write coil and the head substrate.

### CROSS-REFERENCE TO RELATED APPLICATION

This application is based upon and claims the benefit of priority of the prior Japanese Patent Application No. 2008-241440, filed on Sep. 19, 2008, the entire contents of which are incorporated herein by reference.

### FIELD

The embodiments discussed herein are related to a magnetic head mounted on a magnetic disk device, such as a hard disk drive and the like and a magnetic disk device itself.

### BACKGROUND

Currently, a magnetic disk device, such as a hard disk drive and the like is mounted on not only a computer but also various products, such as a portable audio player, a video recorder and the like.

In order to realize the high record density of a magnetic disk device, the flying height of a magnetic head has decreased every year and currently is approximately 10 nm.

However, the flying height of the head varies depending on environmental factors, such as temperature, air pressure and the like, the thermal expansion of a write coil by writing at the time of writing, variations in the processed shape of the air bearing surface (ABS) of a head slider itself mounted on a magnetic head and the like.

For that purpose, a technology for building a heater in a magnetic head, heating it by flowing electric current through it, thermally transforming the magnetic head, protruding the magnetic pole tip of the magnetic head and narrowing space between the magnetic pole tip and a magnetic disk surface is known (for example, see Patent documents 1 and 2).

In the design of a heater, low power consumption is picked up as an important item. It is necessary to efficiently protrude the heater with a small amount of heat and Patent document 3 discloses a technology for efficiently protruding the heater by reducing the sheet resistance of a read unit connected to a heating unit in series.

Furthermore, in order to increase the pole tip protrusion of a heater, Patent document 4 discloses the provision of a thermal insulation layer on the drain end side of a write element and Patent document 5 discloses reversing the arrangement of a recording element and a reproduction element and inserting a thermal insulation layer in between the write element and a read element.

Patent document 1: Japanese Laid-open Patent Publication No. H5-20635

Patent document 2: U.S. Pat. No. 5,991,113

Patent document 3: Japanese Laid-open Patent publication No. 2004-335069

Patent document 4: Japanese Laid-open Patent publication No. 2004-199797

Patent document 5: Japanese Laid-open Patent publication No. 2007-280502

### SUMMARY

According to an aspect of the invention, an magnetic head provided on the drain end side of a head substrate constituting a head slider includes a heater, a write coil, a shield, an insulation layer between the heater and the head substrate, a thermal insulation layer whose heat conductivity is lower than the insulation layer and a thermal radiation layer whose heat conductivity is higher than the shield. The thermal insulation layer is disposed between the heater and the head substrate, and the thermal radiation layer is disposed between the write coil and the head substrate.

The object and advantages of the invention will be realized and attained by means of the elements and combinations particularly pointed in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration of the magnetic disk device in the preferred embodiment of the present invention.

FIG. 2 is a configuration of the head slider in the preferred embodiment of the present invention.

FIG. 3A is a cross-sectional view of the magnetic head in the first preferred embodiment.

FIG. 3B is a perspective view from the process surface of the magnetic head in the first preferred embodiment.

FIG. 4 is a graph illustrating the pole tip protrusion at the time of write coil heating.

FIG. 5 is a graph illustrating the pole tip protrusion at the time of heater heating.

FIG. 6 is a cross-sectional view of the magnetic head in the second preferred embodiment.

FIG. 7 is a cross-sectional view of the magnetic head in the third preferred embodiment.

FIG. 8 is a cross-sectional view of the magnetic head in the fourth preferred embodiment.

### DESCRIPTION OF EMBODIMENTS

As the design factor of the heater of a magnetic head, there are the improvement of protrusion efficiency at the time of heater energization and the reduction of the amount of control of a heater. Specifically, when the efficiency of a heater is high (the pole tip protrusion per unit of heating is large), the heat load of a reproduction element (read element) and a heater can be reduced and also the power consumption of the entire device can be suppressed.

In order to reduce the amount of control of a heater, it is necessary to reduce write coil heating at the time of record being a fly change factor and element protrusion caused when environmental temperature changes.

The protrusion of a heater and protrusion due to the heating of a write coil by energization take the same heat radiating route (heat caused by a heater and a write coil reaches an ALTiC substrate via a shield) and by thickening aluminum oxide between the alutic substrate and the shield and increasing heat resistance between the heater and the ALTiC substrate, the protrusion efficiency of the heater can be improved. However, simultaneously, the protrusion of the write coil increases by the same principle and the amount of control of the heater also increases.

Similarly, even when in order to reduce protrusion due to the heating of a write coil by energization, the protrusion aluminum oxide between protrusion by the heating of a write coil by energization and the shield is thinned and heat resistance between the heater and the ALTiC substrate can be reduced, protrusion due to the heating of a write coil by energization can be also reduced according to the above-described trade-off relation. Therefore, a structure in which both can be compatible is required.

In Patent document 5, in order to solve the above-described problem, a record element (write element) and a reproduction element (read element) are conversely disposed for the ALTiC substrate (head substrate) and the write coil is disposed in the neighborhood of the ALTiC substrate.

However, in order to manufacture it with the less variations of the reproduction element, a plane surface like the ALTiC substrate is necessary and it is very difficult to manufacture a reproduction element after the manufacturing process of a record element.

Preferred embodiments of the present invention will be explained below with reference to the drawings.

Firstly, a magnetic disk device and a head slider on each of which the magnetic head in the preferred embodiment is mounted will be explained.

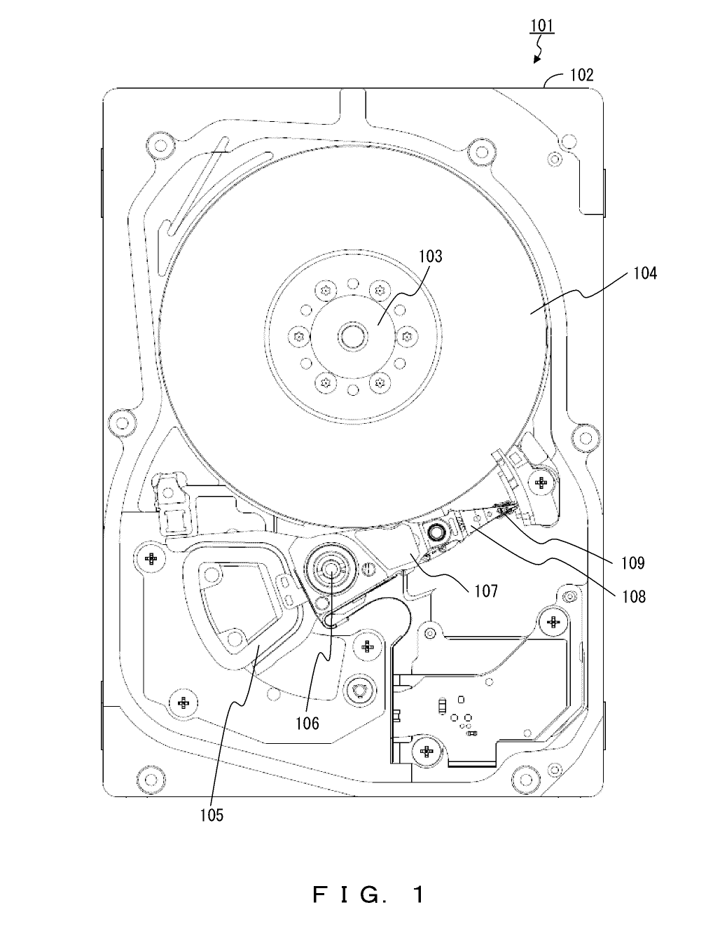

FIG. 1 is a configuration of the magnetic disk device in the preferred embodiment of the present invention.

The magnetic disk device 101 in this preferred embodiment is provided with a magnetic disk 104 rotated/driven by a spindle motor 103 in a rectangular box-shaped cabinet 102.

An arm 107 which can be rotated/moved around a support shaft 106 by an actuator 105 is disposed on the side of the magnetic disk 104. A suspension 108 is attached to the tip of the arm 107 and a head slider 109 is attached to the tip of the suspension 108.

When the magnetic disk 104 rotates, pressure is generated by air stream flowed into between the head slider 109 and the disk 104 and the head slider 109 flies above the disk 104 at fine intervals by the pressure.

By rotating/moving the arm 107 around the support shaft 106 by the actuator 105, The head slider 109 moves in the diameter direction of the magnetic disk 104 on the magnetic disk 104 and reads/writes information from/into the magnetic disk 104.

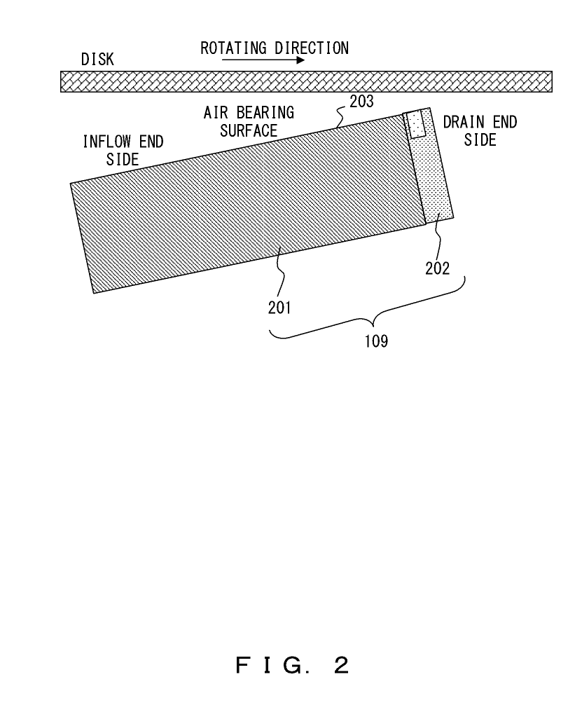

FIG. 2 is a configuration of the head slider in the preferred embodiment of the present invention.

The head slider 109 includes a head substrate 201 and a magnetic head 202.

The head substrate 201 is composed of, for example, ALTiC.

The magnetic head 202 is formed on the drain end side of the head substrate 201 by piling the films of a plurality of materials.

The surface of the head slider 109, opposed to the magnetic disk 104 is called air bearing surface (ABS).

When the magnetic disk 104 rotates, pressure is generated by air stream flowed into between the head slider 109 and the disk 104 and the head slider 109 flies above the disk 104 at fine intervals by the pressure.

The side on which air flows in and the side on which air flows out, of the head slider 109 are called an inflow end side and a drain end side, respectively. The magnetic head 202 is formed on the drain end side.

In FIG. 2, the rotating direction of a disk is from left to right.

The above-described configurations of the magnetic disk device and the head slider are common in each of the following preferred embodiments. In the following explanation, since components to which the same reference numerals are attached in the drawings are the same components or they exert the same effect, their explanations are sometimes omitted.

### First Embodiment

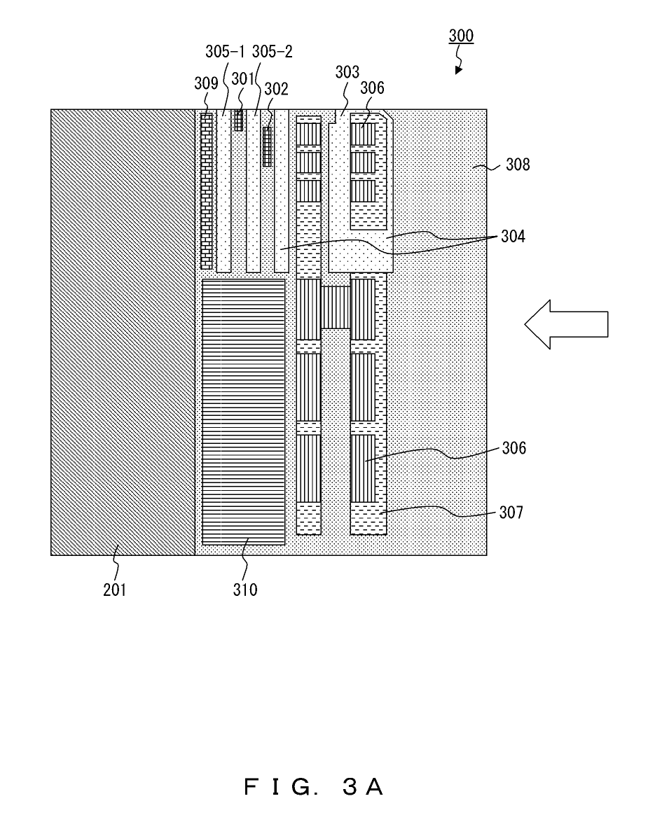

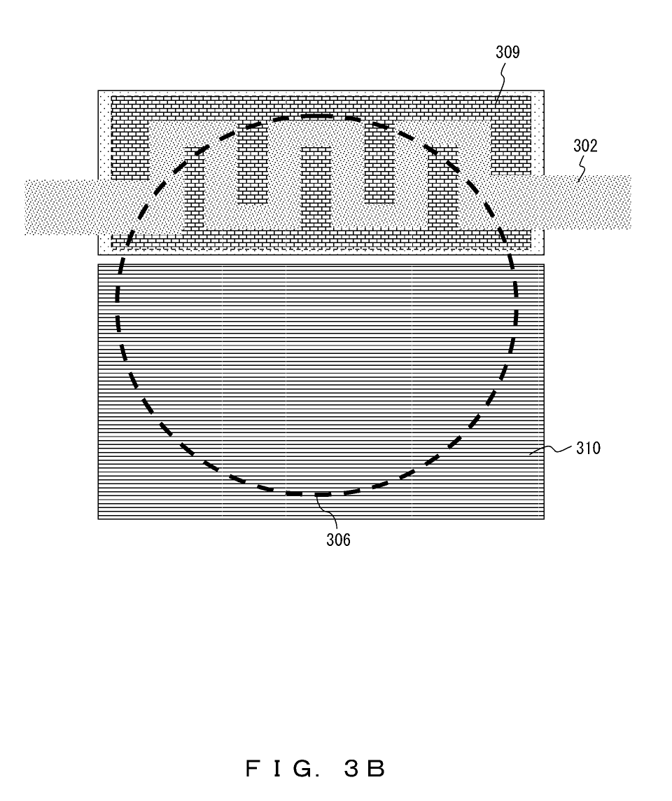

FIG. 3A is a cross-sectional view of the magnetic head in the first preferred embodiment.

FIG. 3B is a perspective view from the process surface (in the arrow direction of FIG. 3A) of the magnetic head in the first preferred embodiment.

A magnetic head 300 includes a read element 301, a heater 302, a main magnetic pole 303, a return yoke 304, shields 305-1 and 305-2, a write coil 306, insulation resin 307, an insulation layer 308, a thermal insulation layer 309 and a thermal radiation layer 310.

In FIGS. 3A and 3B, the air bearing surfaces 203 are the upper sides of the head substrate 202 and the magnetic head 300.

The read element 301 is disposed between the two shields 305-1 and 305-2. There is the insulation layer 308 between the read element 301 and the shield 305-1, and the read element 301 and the shield 305-2. For the read element 301, an MR (magnetoresistive) sensor, a GMR (giant magnetoresistive) sensor, a TMR (tunneling magnetoresistive) sensor or the like is used.

The heater 302 is disposed between the shield 305-2 near the drain end side and the return yoke 304. There is the insulation layer 308 between the heater 302 and the shield 305-2, and the heater 302 and the return yoke 304. The heater 302 generates heat by flowing electric current through it and the shape of the air bearing surface of the magnetic head 300 changes by the heat.

As viewed from the process surface, the heater 302 is shaped in a rectangular wave, and the area of the heater 302 and the area of the thermal insulation layer 309 overlaps, and the heater 302 is positioned on the air bearing surface side of the thermal radiation layer 310.

Electric current is made to flow through the write coil 306 at the time of writing and magnetic flux is generated. Furthermore, the write coil 306 is covered with the insulation resin 307. When electric current is made to flow through the write coil 306, magnetic flux is generated and data is written into the magnetic disk by magnetic flux that leaks from the magnetic gap of the main magnetic pole 303.

A recording head includes the write coil 306, the main magnetic pole 303 and the return yoke 304. The recording head is formed on the drain end side of the read element 301.

The shield 305 is used to shield the read element 301 from external magnetism and for it, permalloy or the like is used.

The insulation layer 308 covers across the entire magnetic head 300, inside the insulation layer 308, respective elements constituting the magnetic head 300, such as the read element 301, the heater 302 and the like are disposed and the insulation layer 308 insulates each element inside the insulation layer 308. For the insulation layer 308, aluminum oxide (alumina) or the like is used.

The thermal insulation layer 309 is disposed between the heater 302 and the head substrate 201, more particularly between the shield 305-1 and the head substrate 201. There is the insulation layer 308 between the head substrate 201 and the thermal insulation layer 309 and between the thermal insulation layer 309 and the shield 305-1.

For the material of the thermal insulation layer 309, amorphous fluororesin, silicon oxide (SiO2), or resist resin is used.

In a thermal route between the heater 302 and the head substrate 201, when there is a layer whose thermal conductivity is lower than the insulator layer 308 whose thermal conductivity is low, the layer acts as a thermal insulation layer. When the insulation layer 308 is alumina, a material whose thermal conductivity is equal to or less than 1.5 m/WK becomes the thermal insulation layer 309.

The thermal radiation layer 310 is disposed between the write coil 306 and the head substrate 201. There is the insulation layer 308 between the head substrate 210 and the thermal radiation layer 310, and between the thermal radiation layer 310 and the write coil 306.

As illustrated in FIG. 3B, when viewed from the process surface, an area where the heater 302 exists and an area where the write coil 306 exists overlap and the heater disposed near the air bearing surface. Therefore, the thermal insulation layer 309 is disposed near the air bearing surface and the thermal radiation layer 310 is disposed away from the air bearing surface of the thermal insulation layer 309.

In a thermal route between the write coil 306 and the head substrate 201, an object whose thermal conductivity is the highest is the shield 305 and if there is an object whose thermal conductivity is higher than the shield 305 between the write coil 306 and the head substrate 201, the object is acts as the thermal radiation layer 310.

When the material of the shield 305 is permalloy, the thermal conductivity of the material of the thermal radiation layer 310 is equal to or more than 24 W/mK.

For the thermal radiation layer 310, copper, aluminum or the like is used as a material whose thermal conductivity is higher than the material of the shield 305. Since copper or aluminum being a non-magnetic material does not affect a magnetic field, it is useful as the thermal radiation layer 310.

Next, a simulation result using the magnetic head in the first preferred embodiment will be illustrated.

The simulation is performed by a finite element method, assuming that the insulation layer 308, the shield 305, the thermal insulation layer 309, the thermal radiation layer 310 and the heat of the write coil 306 and the heater 302 are alumina, permalloy, 0.3 μm amorphous fluororesin, 3 μm copper and 5 mW, respectively, as the first preferred embodiment 1.

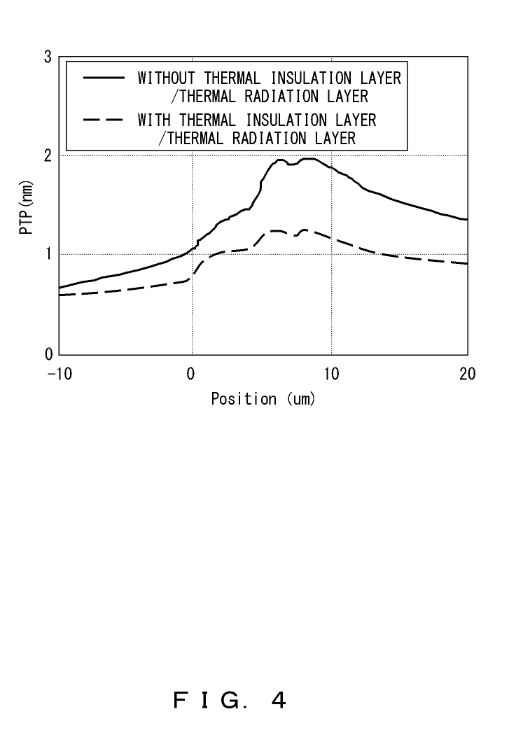

FIG. 4 is a graph illustrating the pole tip protrusion at the time of write coil heating.

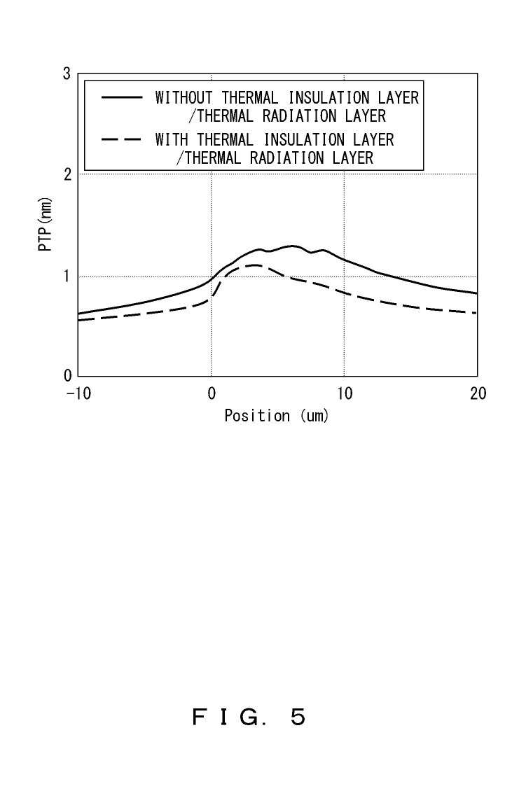

FIG. 5 is a graph illustrating the pole tip protrusion at the time of heater heating.

The vertical and horizontal axes indicate pole tip protrusion (PTP) (nm) and the position on the ABS of the header slider, respectively. The origin of the horizontal axis is the boundary between the head substrate 201 and the magnetic head 300, and plus and minus directions are the drain end and inflow end sides, respectively.

A solid line and a dotted line indicate pole tip protrusion in the case where there is neither the thermal insulation layer 309 nor the thermal radiation layer 310 and pole tip protrusion in the case where there are both the thermal insulation layer 309 and the thermal radiation layer 310. The respective reduction effects at the maximum protrusion position are indicated in Table 1 below.

TABLE 1

| | First embodiment 1 |
|---|---|
| Thermal insulation layer | Amorphous fluororesin |
| Thermal radiation layer | Copper |
| Pole tip protrusion reduction | 37% |
| effect for write coil energization | |
| Pole tip protrusion reduction | 14% |
| effect for heater energization | |

It is found from the simulation result that although [symbol] pole tip protrusion at the time of heater energization is reduced 14% at most, pole tip protrusion at the time of write coil energization can be greatly reduced 37%. Therefore, the above-described trade-off between the efficient pole tip protrusion by a heater and the reduction of unnecessary pole tip protrusion at the time of write coil energization can be improved.

By using a material whose thermal conductivity is higher than a shield material and whose thermal expansion co-efficient is smaller than the head substrate, so called low thermal expansion material, as a thermal radiation layer, unnecessary pole tip protrusion at the time of environmental temperature change as well as the pole tip protrusion at the time of write coil energization can be reduced. For the material of such a thermal radiation layer, silicon carbide, tungsten, silicon nitride, aluminum nitride or molybdenum is used. In this case, since pole tip protrusion at the time of environmental temperature change can be reduced in addition to pole tip protrusion at the time of write coil energization, the amount of control of a heater can be reduced more.

The effect obtained in the case where the thermal radiation layer 310 is silicon carbide (first embodiment 2) is indicated in Table 2 below.

TABLE 2

| | First embodiment 2 |
|---|---|
| Thermal insulation layer | Amorphous fluororesin |
| First thermal radiation layer | Silicon carbide |
| Second thermal radiation layer | — |
| Pole tip protrusion reduction | 31% |
| effect for write coil energization | |
| Pole tip protrusion reduction | 9% |
| effect for heater energization | |
| Pole tip protrusion reduction effect at the | 34% |
| time of environmental temperature change | |

As indicated in Table 2, although pole tip protrusion at the time of heater energization is reduced 9% at most, pole tip protrusion at the time of write coil energization can be greatly reduced 31%. Therefore, the trade-off can be improved. Furthermore, pole tip protrusion reduction effect at the time of environmental temperature change can be also reduced 34%.

According to the magnetic head in the first preferred embodiment, the heat of a heater is shut down by a thermal insulation layer, heat resistance between the heater 302 and the head substrate 201 increases and the pole tip protrusion efficiency of the heater 302 secured. Meanwhile since the heat of the write coil 306 escapes to the head substrate 201 via the thermal radiation layer 310, heat resistance between the write coil 306 and the head substrate 201 decreases and unnecessary pole tip protrusion at the time of write coil energization can be reduced. Therefore, unnecessary pole tip protrusion of the write coil 306 can be greatly reduced while pole tip protrusion efficiency at the time of heater 302 energization can be secured.

By using a low thermal expansion material as the thermal radiation layer, pole tip protrusion at the time of environmental temperature change can be also reduced.

### Second Embodiment

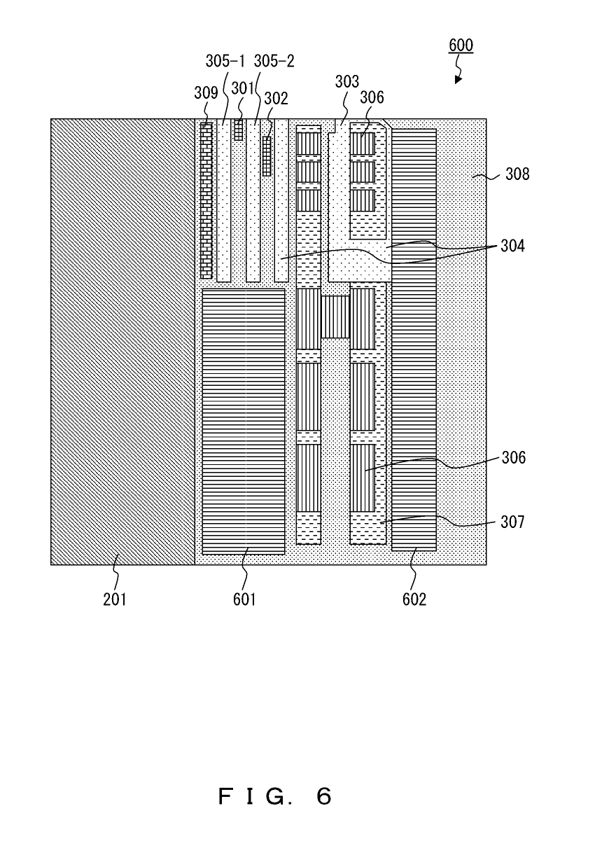

FIG. 6 is a cross-sectional view of the magnetic head in the second preferred embodiment.

A magnetic head 600 in the second preferred embodiment includes a read element 301, a heater 302, a main magnetic pole 303, a return yoke 304, shields 305-1 and 305-2, a write coil 306, insulation resin 307, an insulation layer 308, a thermal insulation layer 309, a first thermal radiation layer 601 and a second thermal radiation layer 602.

In FIG. 6, the air bearing surfaces 203 are the upper sides of the head substrate 201 and the magnetic head 600.

The first thermal radiation layer 601 corresponds to the thermal radiation layer 310 in the first preferred embodiment.

Since the read element 301, the heater 302, the main magnetic pole 303, the return yoke 304, the shields 305-1 and 305-2, the write coil 306, the insulation resin 307, the insulation layer 308, the thermal insulation layer 309 and the first thermal radiation layer 601 are the same as those in the first preferred embodiment, their explanations are omitted here. The second preferred embodiment further includes the second thermal radiation layer 602, compared with the first preferred embodiment.

The second thermal radiation layer 602 is disposed on the drain end side than the write coil 306.

For the second thermal radiation layer 602, a material whose thermal conductivity is higher than the material of the shield 305 and whose thermal expansion coefficient is smaller (low thermal expansion material) than the head substrate 201 is used.

For example, for the material of the thermal radiation layer 602, silicon carbide, tungsten, silicon nitride, aluminum nitride or molybdenum is used.

Although the heat of the write coil 306 also moves to the second thermal radiation layer 602, the second thermal radiation layer 602 is a material whose thermal expansion coefficient is small. Therefore, pole tip protrusion can be reduced. Furthermore, since there is the second thermal radiation layer 602 whose thermal expansion coefficient is small, pole tip protrusion at the time of environmental temperature change can be also reduced.

A simulation result in the case where the first thermal radiation layer 601 and the second thermal radiation layer 602 are copper and silicon carbide, respectively, in the second preferred embodiment (second embodiment 1) is indicated in Table 3 below.

TABLE 3

| | Second embodiment 1 |
|---|---|
| Thermal insulation layer | Amorphous fluororesin |
| First thermal radiation layer | Copper |
| Second thermal radiation layer | Silicon carbide |
| Pole tip protrusion reduction | 46% |
| effect for write coil energization | |
| Pole tip protrusion reduction | 19% |
| effect for heater energization | |
| Pole tip protrusion reduction effect at the | 14% |
| time of environmental temperature change | |

As indicated in Table 3, although pole tip protrusion at the time of heater energization is reduced 19% at most, pole tip protrusion at the time of write coil energization is greatly reduced 46% and pole tip protrusion at the time of environmental temperature change can be reduced 14% in addition to the improvement of the trade-off.

An effect obtained when both the first thermal radiation layer 601 and the second thermal radiation layer 602 are silicon carbide in the second preferred embodiment (second embodiment 2) is indicated in Table 4 below.

TABLE 4

| | Second embodiment 2 |
|---|---|
| Thermal insulation layer | Amorphous fluororesin |
| First thermal radiation layer | Silicon carbide |
| Second thermal radiation layer | Silicon carbide |
| Pole tip protrusion reduction | 41% |
| effect for write coil energization | |
| Pole tip protrusion reduction | 14% |
| effect for heater energization | |
| Pole tip protrusion reduction effect at the | 83% |
| time of environmental temperature change | |

As indicated in Table 4, when the first and second thermal radiation layer are silicon carbide, although pole tip protrusion at the time of heater energization is reduced 14% at most, pole tip protrusion at the time of write coil energization is greatly reduced 41% and pole tip protrusion at the time of environmental temperature change can be reduced 83% in addition to the improvement of the trade-off.

According to the magnetic head in the second preferred embodiment, by providing the second thermal radiation layer 602, unnecessary pole tip protrusion at the time of write coil energization can be greatly reduced compared with the first preferred embodiment while pole tip protrusion efficiency at the time of heater energization is secured. Pole tip protrusion at the time of environmental temperature change can be also reduced.

### Third Embodiment

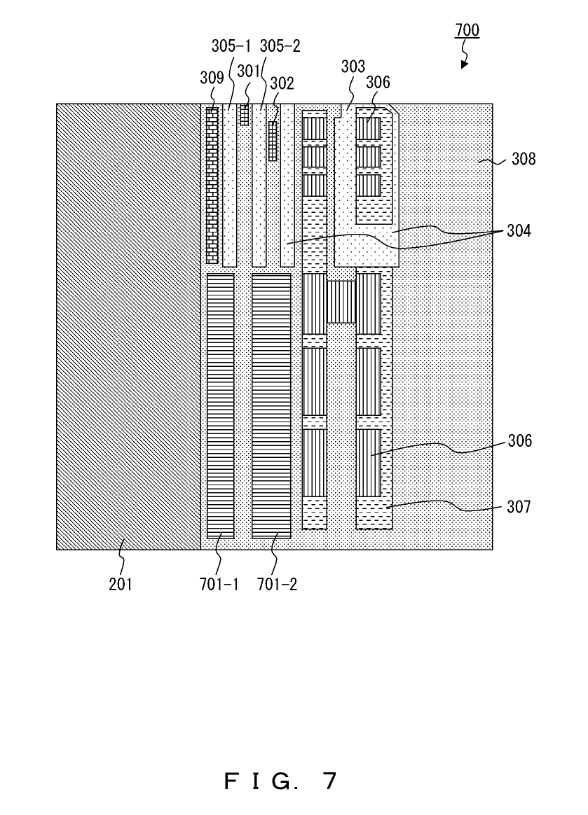

FIG. 7 is a cross-sectional view of the magnetic head in the third preferred embodiment.

A magnetic head 700 in the third preferred embodiment includes a read element 301, a heater 302, a main magnetic pole 303, a return yoke 304, shields 305-1 and 305-2, a write coil 306, insulation resin 307, an insulation layer 308, a thermal insulation layer 309 and thermal radiation layers 701-1 and 701-2.

In FIG. 7, the air bearing surfaces 203 are the upper sides of the head substrate 201 and the magnetic head 700.

The thermal radiation layers 701-1 and 701-2 are disposed between the write coil 306 and the head substrate 201. There is the insulation layer 308 between the thermal radiation layers 701-1 and 701-2.

The thermal radiation layers 701-1 and 701-2 correspond to ones obtained by dividing the thermal radiation 310 layer in the first preferred embodiment.

Since the read element 301, the heater 302, the main magnetic pole 303, the return yoke 304, the shields 305-1 and 305-2, the write coil 306, the insulation resin 307, the insulation layer 308, the thermal insulation layer 309 and the thermal radiation layer 701 are the same as those in the first preferred embodiment, their explanations are omitted here.

In the third preferred embodiment, the thermal radiation layer is divided into two in the layer direction.

Although in the third preferred embodiment, the thermal radiation layer is divided into two, it can be also divided into more.

According to the magnetic head 700 in the third preferred embodiment, the heat of a heater is shut down by a thermal insulation layer, heat resistance between the heater 302 and the head substrate 201 increases and pole tip protrusion efficiency of the heater 302 can be secured. Meanwhile since the heat of the write coil 306 escapes to the head substrate 201 via the thermal radiation layers 701-1 and 701-2, heat resistance between the write coil 306 and the head substrate 201 decreases and unnecessary pole tip protrusion at the time of write coil energization can be reduced. Therefore, unnecessary pole tip protrusion at the time of write coil energization can be greatly reduced while pole tip protrusion efficiency at the time of heater 302 energization is secured.

Furthermore, according to the magnetic head 700 in the third preferred embodiment, since the magnetic head 700 is formed by a thin-film process, by dividing and generating the thermal radiation layers 701-1 and 701-2 in the layer direction, the thermal radiation layer 701 can be easily generated.

### Fourth Embodiment

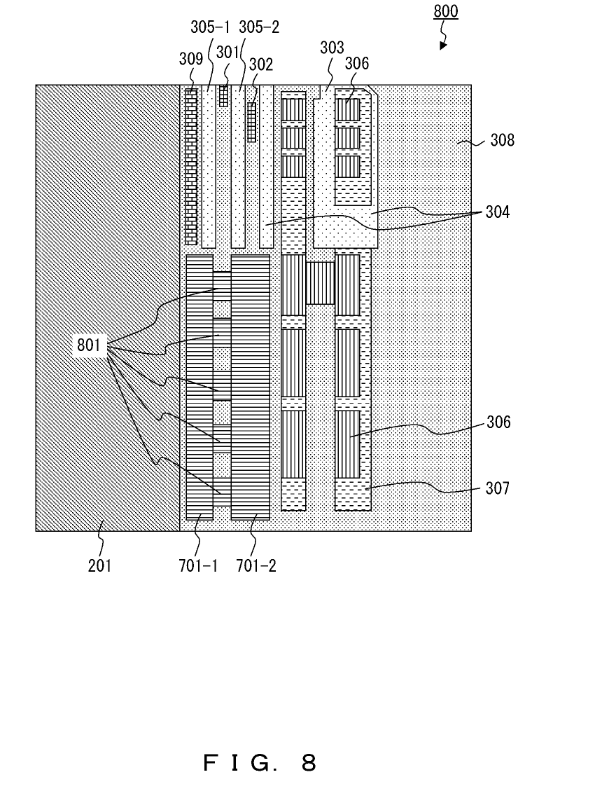

FIG. 8 is a cross-sectional view of the magnetic head in the fourth preferred embodiment.

A magnetic head 800 in the fourth preferred embodiment includes a read element 301, a heater 302, a main magnetic pole 303, a return yoke 304, shields 305-1 and 305-2, a write coil 306, insulation resin 307, an insulation layer 308, a thermal insulation layer 309, thermal radiation layers 701-1 and 701-2, and a thermal via 801.

In FIG. 8, the air bearing surfaces 203 are the upper sides of the head substrate 201 and the magnetic head 800.

Since the read element 301, the heater 302, the main magnetic pole 303, the return yoke 304, the shields 305-1 and 305-2, the write coil 306, the insulation resin 307, the insulation layer 308, the thermal insulation layer 309 and the thermal radiation layers 701-1 and 701-2 are the same as those in the third preferred embodiment, their explanations are omitted here.

The magnetic head 800 in the fourth preferred embodiment further includes a thermal via 801, compared with the magnetic head 700 in the third preferred embodiment.

The thermal via 801 thermally connects the thermal radiation layers 701-1 and 701-2.

According to the magnetic head in the fourth preferred embodiment, heat resistance between the thermal radiation layers 701-1 and 701-2 can be reduced by the thermal via 801. Therefore, unnecessary pole tip protrusion can be reduced more than the third preferred embodiment while pole tip protrusion efficiency at the time of heater 302 energization is secured.

All examples and conditional language recited herein are intended for pedagogical purposes to aid the reader in understanding the invention and the concepts contributed by the inventor to furthering the art, and are to be construed as being without limitation to such specifically recited examples in the specification relate to a showing of the superiority and inferiority of the invention. Although the embodiment (s) of the present inventions have been described in detail, it should be understood that various changes, substitutions, and alteration could be made hereto without departing from the spirit and scope of the invention.

What is claimed is:

1. A magnetic head provided on a drain end side of a head substrate constituting a head slider, comprising:
a heater;
a write coil;
a shield;
an insulation layer between the heater and the head substrate;
a thermal insulation layer whose thermal conductivity is lower than the insulation layer; and
a thermal radiation layer whose thermal conductivity is higher than the shield, wherein
the thermal insulation layer is disposed between the heater and the head substrate and
the thermal radiation layer is disposed between the write coil and the head substrate.

2. The magnetic head according to claim 1, wherein
the thermal insulation layer is disposed nearer an air bearing surface of the head slider than the thermal radiation layer.

3. The magnetic head according to claim 1, wherein
the thermal insulation layer is amorphous fluororesin, silicon oxide or resist resin.

4. The magnetic head according to claim 1, wherein
the thermal radiation layer is a non-magnetic material.

5. The magnetic head according to claim 4, wherein
the thermal radiation layer is copper or aluminum.

6. The head slider according to claim 1, wherein
the thermal radiation layer has a smaller thermal expansion coefficient than the head substrate.

7. The magnetic head according to claim 6, wherein
the thermal radiation layer is silicon carbide, tungsten, silicon nitride, aluminum nitride, or molybdenum.

8. The magnetic head according to claim 1, wherein
another thermal radiation layer whose thermal conductivity is higher than the shield is disposed nearer a drain end side than the write coil.

9. The magnetic head according to claim 8, wherein
the another thermal radiation layer has a smaller thermal expansion coefficient than the head substrate.

10. The magnetic head according to claim 9, wherein
the another thermal radiation layer is silicon carbide, tungsten, silicon nitride, aluminum nitride, or molybdenum.

11. The magnetic head according to claim 1, wherein
the thermal radiation layer is divided into a plurality of layers and is formed.

12. The magnetic head according to claim 11, wherein
a plurality of separated thermal radiation layers is connected by a thermal via.

13. A magnetic disk device, comprising:
a magnetic disk; and
a head slider provided with a head substrate and a magnetic head on a drain end side of the head substrate, for reading/writing data recorded on the magnetic disk, wherein
the magnetic head comprises
a heater;
a write coil;
a shield;
an insulation layer between the heater and the head substrate;
a thermal insulation layer whose thermal conductivity is lower than the insulation layer; and
a thermal radiation layer whose thermal conductivity is higher than the shield, wherein
the thermal insulation layer is disposed between the heater and the head substrate and
the thermal radiation layer is disposed between the write coil and the head substrate.
